(19) United States
(12) Patent Application Publication
(10) Pub. No.: US 2023/0191433 A1
(43) Pub. Date: Jun. 22, 2023

(54) SPRAYER WITH TENTACLE PUMP

(71) Applicant: THE FOUNTAINHEAD GROUP, INC., New York Mills, NY (US)

(72) Inventor: Andrew C. Putrello, Utica, NY (US)

(73) Assignee: THE FOUNTAINHEAD GROUP, INC., New York Mills, NY (US)

(21) Appl. No.: 17/912,718

(22) PCT Filed: Mar. 18, 2021
(86) PCT No.: PCT/US2021/022977

§ 371 Date: Sep. 19, 2022

Related U.S. Application Data
(60) Provisional application No. 62/991,149, filed on Mar. 18, 2020.

(51) Int. Cl. B05B 9/04; B05B 12/00

(52) U.S. Cl. CPC B05B 9/0426; B05B 9/0416; B05B 9/0423; B05B 12/002

(57) ABSTRACT

An electrically powered, compact, ready to use sprayer that includes a main housing. When the sprayer is used in conjunction with an electric motor, self-feeding undulating tentacles, a spinning element, a spherical boot, spherical boot outlet, feed hose, and an extended wand outlet it is able to pump low and high viscosity fluid, create a liquid spray, and dispense fluid in the forward direction with very few moving parts and minimum energy.

### CROSS-REFERENCE TO RELATED APPLICATION

The present application relates and claims priority to U.S. Provisional Application No. 62/991,149, filed Mar. 18, 2020, the entirety of which is hereby incorporated by reference.

### FIELD OF THE INVENTION

The present disclosure is directed generally to ready to use sprayers, and more particularly to a compact, portable liquid dispenser that uses an undulating self-feeding tentacle pumping system and a multi-directional spherical pressure-control boot.

### BACKGROUND

There are numerous ways to pump, convey, or move fluid. There are also numerous ways to spray, atomize, and dispense fluids. Many of the pumping and dispensing mechanisms currently in use require complex pumps, excessive electrical or thermal power, high pressure, are restricted to low viscosity fluids, generate excessive friction, are mechanically complex, rigid, bulky, noisy, difficult to clean, require high pressure hoses, difficult and expensive to manufacture, difficult to prime, and are susceptible to clogging.

Accordingly, there is a need in the art for a ready to use sprayer that uses an undulating tentacle pump that allows the motor to impart rotational energy upon the fluid that it pumps.

Accordingly, there is a need in the art for a ready to use sprayer that relays the naturally rotating fluid pumped by the undulating tentacles into a spherical boot where rotation can continue and is enhanced by super cavitation that is induced by inside surface features within the spherical boot.

Accordingly, there is a need in the art for a ready to use sprayer that can further enhance fluid rotation by using a spinning element that also creates a hole in the fluid thereby pulling the fluid away from the seal separating the motor from the drive shaft thus preventing a potential leaking point.

Accordingly, there is a need in the art for a ready to use sprayer that can then direct fluid as it is simultaneously pumped up by the undulating tentacles and pulled down by the spinning element by squeezing the fluid flow through a predetermined exit point into an extended wand where it is dispensed in the forward direction thus providing a low power, quiet, easy to clean, portable ready to use sprayer without the need to generate high pressure or heat.

### SUMMARY

To solve the above-mentioned problems, embodiments of the sprayer with tentacle pump are directed to a ready to use sprayer. According to one embodiment the sprayer is accomplished by an electrically powered, compact, ready to use sprayer that is able to pump low and high viscosity fluid, create a liquid spray, and dispense fluid in the forward direction with very few moving parts and minimum energy.

According to an aspect is a sprayer adapted for connection to a source of fluid, comprising a housing in which a motor and drive shaft are operably positioned, the motor being selectively actuable by a user and upon actuation imparts rotary motion to the drive shaft; a plurality of tentacles each of which includes a first end that is interconnected to the drive shaft and a second end that is adapted for insertion in the fluid; a feed hose in which the plurality of tentacles extend; a boot attached to the housing adjacent the drive shaft and in which a portion of the plurality of tentacles, adjacent their first ends, are contained, the boot having an outlet; and a wand having an inlet in fluid communication with the outlet of the boot and an outlet from which the fluid is expelled.

According to an embodiment, the sprayer further comprises a spinning element attached to the drive shaft and to which the first ends of the plurality of tentacles are attached.

According to an embodiment, the spinning element comprises a first end attached to the drive shaft that is of a first dimension and a body that extends outwardly from the first end and is of a dimension greater than that of the first end.

According to an embodiment, the spinning element is triangular in shape with the first end being defined by one comer of the triangle.

According to an embodiment, the boot comprises a plurality of grooves formed on its interior surface.

According to an embodiment, the boot is spherical in shape.

According to an embodiment, the wand comprises a first converging fluid pathway formed in its interior;

According to an embodiment, the wand comprises a second converging fluid pathway extending between the first fluid pathway and the outlet.

According to an embodiment, the wand comprises a diverging fluid pathway extending between the first converging fluid pathway and the inlet.

According to an embodiment, the sprayer further comprises a switch positioned on the exterior of the housing and which is selectively actuable by a user to actuate the motor.

According to an embodiment, the sprayer further comprises a power source electrically connected to the switch.

According to an embodiment, the sprayer further comprises a charging port positioned on the housing and being electrically connected to the power source.

According to an embodiment, the sprayer further comprises a seal through which the drive shaft extends and positioned within the boot to seal fluid within the boot from escaping towards the motor.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1 is a side elevation view, in section, of a sprayer, in accordance with an embodiment.

FIG. 2 is a perspective view, in section, of the boot portion of a sprayer, in accordance with an embodiment.

FIG. 3 is a perspective view of the boot portion of a sprayer, in accordance with an embodiment.

FIG. 4 is an elevation view, in section, of the wand portion of a sprayer, in accordance with an embodiment.

FIG. 5 is a side elevation view, in section, of a sprayer, in accordance with an embodiment.

### DETAILED DESCRIPTION OF EMBODIMENTS

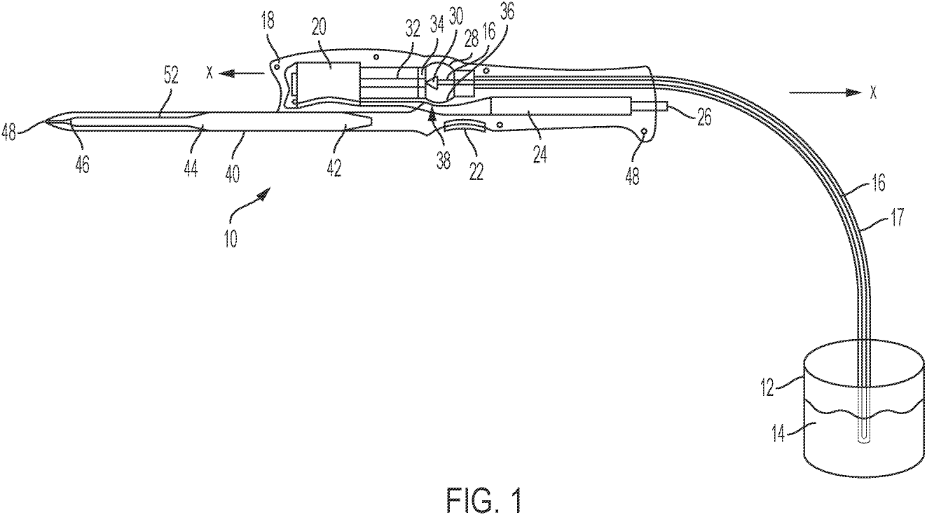

The present disclosure describes a ready to use sprayer 10. Referring to FIG. 1, in one embodiment, ready to use sprayer 10 is fluidly connected to a container 12 having a source of fluid 14 contained therein. Sprayer 10 comprises a plurality of tentacles 16 (all contained within a fed hose 17) that function as pumping mechanisms and move fluid 14 from the container 12 and cause it to be expelled from the sprayer as will be described in greater detail hereinafter.

Sprayer 10 comprises a housing 18 in which a motor 20 is operably positioned. Motor 20 is selectively actuated by a user who can move a switch 22 (that is attached to the housing 18) between on and off positions. Switch 22 is electrically coupled to motor 20 and is powered by a power source 24 (e.g., a battery) also positioned within housing 18. A charging port 26 may be provided and accessible on the exterior of housing 18 and can be electrically coupled to power source 24 to provide a means to recharge the power source.

A spherical/donut-shaped boot 28 is fixedly interconnected within housing 18 to motor 20 and feed hose 17 terminates at one end at the boot 28. Tentacles 16 have one of their terminal ends positioned within boot 28 where they are affixed to a spinning element 30 mounted to the end of a drive shaft 32 that extends from and is driven in rotational motion about axis X-X by motor 20. As motor 20 is actuated, drive shaft 32 rotates about axis X-X causing spinning element 30 and tentacles 16 to rotate as well. The rotational motion imparted to tentacles 16 causes them to undulate along their entire lengths. As will be described hereinafter, this undulating motion imparted to tentacles 16 functions as a pump to move fluid 14 from container 12 along the lengths of tentacles 16 and into boot 28.

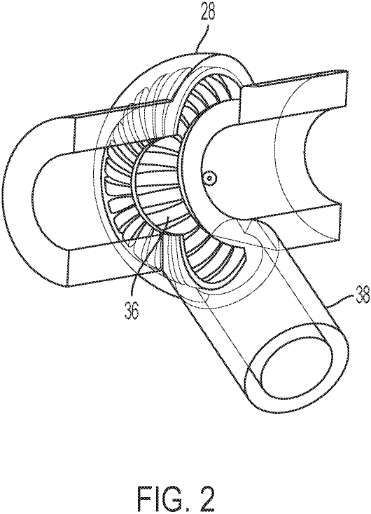

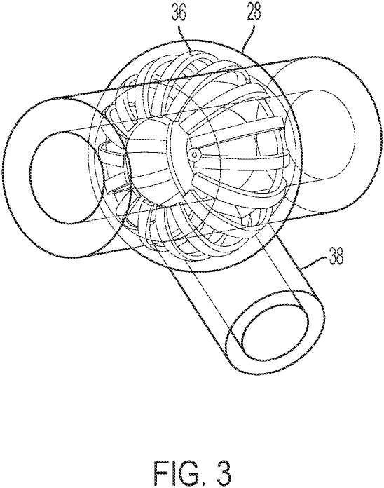

Boot 28 is sealed relative to motor 20 by a seal 34 that extends around drive shaft 32 as it enters boot 28. As the fluid moves along tentacles 16 and into boot 28 it will be flung by centrifugal force off the end of tentacles 16 and into boot 28. Boot 28 includes a plurality of grooves 36 formed on its interior surface and includes a fluid outlet 38 through which the fluid can exit the boot 28 embodiments of the boot can be seen in FIGS. 2 and 3. As the fluid moves and is impacted by grooves 36, additional cavitation effects are imparted, thereby lowering drag and increasing the fluid’s rotational velocity within boot 28.

Spinning element 30 is shaped with its end nearest seal 34 being its narrowest dimension; triangular shape, parabolically shaped, and hemi-parabolically shaped are all possible shapes for spinning element 30. Having the narrowest part of spinning element 30 nearest seal 34 creates a low pressure towards the larger dimensioned portions of spinning element 30 and its smooth exterior surface over which the fluid passes creates a vortex of sorts at the junction of drive shaft 32 and seal 34, thus further minimizing/assisting in the elimination of fluid from that opening. Additionally, the seal may be composed of a low friction material with minimal drag effect to facilitate the fluid pulling away from seal 34.

As the fluid 14 is pulled away from the small tip of the spinning element 30 towards the larger diameter of the spinning element 30 the fluid 14 is accelerated and ejected in the outward direction from within spherical boot 28 thus combining with the fluid 14 that is rotating as it is pumped up by the tentacles 16 and held in rotation within the spherical boot 28, thus building pressure within the spherical boot 28 and ultimately forcing the fluid 14 through the spherical boot outlet 38.

Additionally, the spherical boot 28 prevents back pressure from forcing fluid 14 back down the feed hose 17, thus functioning as a one-way valve. The position of the spinning element 30 can be adjusted to raise and lower the outlet 38. Ideally, the spherical boot 28 should preferably be designed to hold an amount of fluid 14 equaling the flow rate of the undulating tentacles 16 to allow for continuous unimpeded flow.

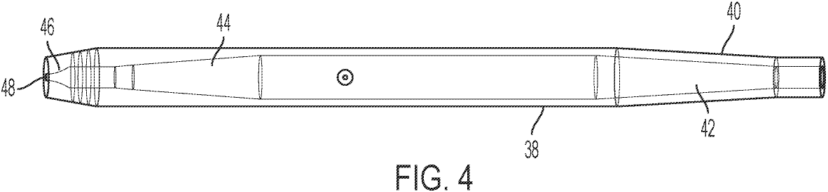

As the fluid 14 is ejected through the spherical boot outlet 38 it enters an extended wand 40. Referring now to FIG. 4, as the fluid 14 leaves the spherical boot outlet 38 and flows into the extended wand 40 it is rapidly expanded by an extended wand expander/diffuser 42. After expansion, the fluid 14 is then stabilized into laminar flow through the extended wand 40. As the fluid 14 continues through the extended wand 40 it is directed through a converging extended wand fluid channel 44 where it is accelerated further. It then passes through a second converging fluid channel 46 for further acceleration just before exiting the extended wand outlet 48.

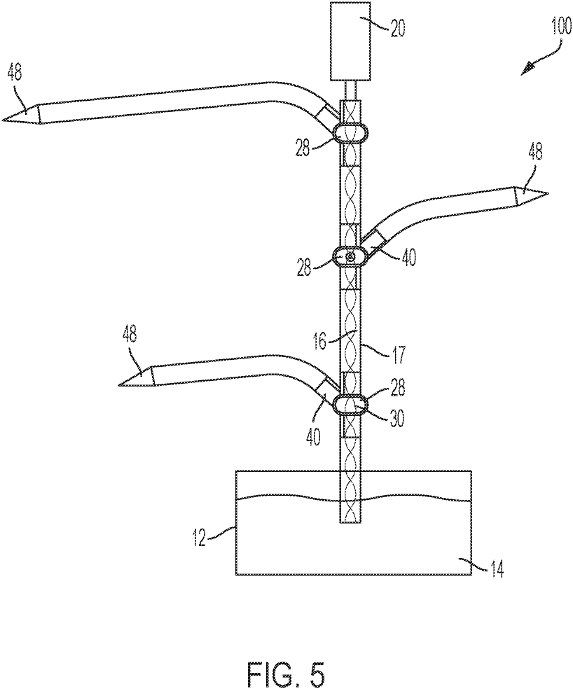

Referring now to FIG. 5, it can be noted that several outlets and cascading spherical boots and spinning elements can be stacked to control and redirect the fluid 14 towards different channels if required; this arrangement of a sprayer 100 (with the same components as sprayer 10). This embodiment can be accomplished additional tentacles between the cascading spherical boots as shown or the spherical elements can be in direct or indirect communication with one another.

The pumping action is enhanced by the vibration caused by the rotating tentacles 16. The pumping volume can also be controlled by the volume of the spherical boot 28, feed hose 17 diameter and durometer, spinning element 30 shape and varying the configuration of tentacles 16. The spinning element 30 is not required but enhances flow through the spherical boot outlet 38 while simultaneously pulling fluid 14 away from the seal 34. It has been shown that seal 34 can be eliminated if the opening between the drive shaft 32 and the exit of the spherical boot 28 is small due to the sucking action at the tip of spinning element 30 and the fluid vortex/hole created. It should also be noted that a large volume of fluid 14 can be moved by using the spherical boot 28 and spinning element 30 without the undulating tentacles 16. The tentacle configuration can also be varied by number.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A sprayer adapted for connection to a source of fluid, comprising:
a. a spherical boot comprising a plurality of grooves formed on its interior surface and an outlet;
b. a hose comprising a first end that terminates within the spherical boot and a second end that is adapted for insertion in the source of fluid;
c. a housing in which a motor and drive shaft are operably positioned, the motor being selectively actuable by a user and upon actuation imparts rotary motion to the drive shaft, wherein the driveshaft is configured to impart a rotary motion on the first end of the hose; and
d. a plurality of tentacles positioned within the hose.

2. (canceled)

3. The sprayer according to claim 1, comprising a second spherical boot in communication with a second outlet of the spherical boot.

4. The sprayer according to claim 1, further comprising a wand having an inlet in fluid communication with the outlet of the spherical boot and an outlet from which the fluid is expelled.

5. The sprayer according to claim 1, further comprising a spinning element attached to the drive shaft and to which the first end of the hose is attached.

6. The sprayer according to claim 5, wherein the spinning element comprises a first end attached to the drive shaft that is of a first dimension and a body that extends outwardly from the first end and is of a dimension greater than that of the first end.

7. A sprayer adapted for connection to a source of fluid, comprising:
a. a housing in which a motor and drive shaft are operably positioned, the motor being selectively actuable by a user and upon actuation imparts rotary motion to the drive shaft;
b. a plurality of tentacles each of which includes a first end that is interconnected to the drive shaft and a second end that is adapted for insertion in the fluid;
c. a feed hose in which the plurality of tentacles extend;
d. a boot attached to the housing adjacent the drive shaft and in which a portion of the plurality of tentacles, adjacent their first ends, are contained, the boot having an outlet; and
e. a wand having an inlet in fluid communication with the outlet of the boot and an outlet from which the fluid is expelled.

8. The sprayer according to claim 7, further comprising a spinning element attached to the drive shaft and to which the first ends of the plurality of tentacles are attached.

9. The sprayer according to claim 8, wherein the spinning element comprises a first end attached to the drive shaft that is of a first dimension and a body that extends outwardly from the first end and is of a dimension greater than that of the first end.

10. The sprayer according to claim 9, wherein the spinning element is triangular in shape with the first end being defined by one corner of the triangle.

11. The sprayer according to claim 7, wherein the boot comprises a plurality of grooves formed on its interior surface.

12. The sprayer according to claim 7, wherein the boot is spherical in shape.

13. The sprayer according to claim 7, wherein the wand comprises a first converging fluid pathway formed in its interior.

14. The sprayer according to claim 13, wherein the wand comprises a second converging fluid pathway extending between the first fluid pathway and the outlet.

15. The sprayer according to claim 7, wherein the wand comprises a diverging fluid pathway extending between the first converging fluid pathway and the inlet.

16. The sprayer according to claim 7, further comprising a switch positioned on the exterior of the housing and which is selectively actuable by a user to actuate the motor.

17. The sprayer according to claim 16, further comprising a power source electrically connected to the switch.

18. The sprayer according to claim 16, further comprising a charging port positioned on the housing and being electrically connected to the power source.

19. The sprayer according to claim 7, further comprising a seal through which the drive shaft extends and positioned within the boot to seal fluid within the boot from escaping towards the motor.

20. A process of dispensing a fluid, the process comprising the steps of:
a. pumping the fluid from a source via a plurality of tentacles into a spherical boot comprising a plurality of groves within a housing;
b. rotating with a spinning element an end of the tentacles that is within the housing causing the tentacles to undulate;
c. pumping fluid into the spherical boot such that the grooves can cause a cavitation effect on the fluid;
d. creating a vortex which pulls the fluid down using the spinning thereby pulling the fluid away from a seal separating a motor from the drive shaft thus preventing a potential leaking point; and
e. forcing the fluid flow through an exit point of the spherical boot into an extended wand where it is dispensed in the forward direction.
